(19) United States
(12) Patent Application Publication
(10) Pub. No.: US 2025/0182255 A1
(43) Pub. Date: Jun. 5, 2025

(54) PROCESSING APPARATUS, PROCESSING METHOD, AND NON-TRANSITORY STORAGE MEDIUM

(71) Applicant: NEC Corporation, Minato-ku, Tokyo (JP)

(72) Inventor: Natsuki Yui, Tokyo (JP)

(73) Assignee: NEC Corporation, Minato-ku, Tokyo (JP)

(21) Appl. No.: 18/842,125

(22) PCT Filed: Mar. 15, 2022
(86) PCT No.: PCT/JP2022/011648

§ 371 Date: Aug. 28, 2024

(51) Int. Cl. G06T 5/75; G06T 5/50; G06T 5/70; G06V 40/16

(52) U.S. Cl. CPC G06T 5/75; G06T 5/70; G06V 40/161; G06T 5/50

(57) ABSTRACT

A processing apparatus (10) according to the present invention includes: a detection unit (11) that detects an object satisfying a predetermined disclosure condition in a processed image; a mask unit (12) that masks the processed image; and a display control unit (13) that displays the entirely masked processed image on a display apparatus, and, in a case where the object satisfying the disclosure condition is detected in the processed image, switches an image to be displayed on the display apparatus from the entirely masked processed image to the processed image masked on an area other than an area where the object satisfying the disclosure condition is captured.

### TECHNICAL FIELD

The present invention relates to a processing apparatus, a processing method, and a storage medium.

### BACKGROUND ART

A technique for processing an image in such a way that a person or an object captured in the image cannot be determined is desired for a purpose of privacy protection and the like. A related technique is disclosed in Patent Documents 1 to 3.

Patent Document 1 discloses a technique for displaying a masked image superimposed a mask image covering only inside of a contour of a person in a processed image on a discriminability-reduced image performed processing of reducing object discriminability on the entire processed image.

Patent Document 2 discloses a technique for displaying a processed image masked only on a detected person area, and, in a case where a person performing a predetermined action is detected, unmasking to the person and thereby displaying the processed image in a visible state of the person.

Patent Document 3 discloses a technique for detecting a pre-registered person in a processed image by using a face matching technique, and displaying the processed image masked a face of a person other than the pre-registered person and not masking a face of the pre-registered person.

### RELATED DOCUMENT

### Patent Document

Patent Document 1: Japanese Patent Application Publication No. 2017-98879
Patent Document 2: Japanese Patent Application Publication No. 2011-91705
Patent Document 3: Japanese Patent Application Publication No. 2004-62560

### DISCLOSURE OF THE INVENTION

### Technical Problem

In a case where a person is detected in a processed image and only an area of the detected person is masked as in the technique disclosed in Patent Documents 2 and 3, there is a problem that a person who is not detected in processing of detecting a person, that is, a missed-detection person, is not masked.

The above problem is solved by masking an entire processed image as in the technique disclosed in Patent Document 1. However, in a case where an entire processed image is masked at all times as in the technique disclosed in Patent Document 1, a content of the processed image cannot be fully recognized. Thus, in a case of the technique disclosed in Patent Document 1, there is a problem that a viewer viewing a processed image may overlook a predetermined event captured in the processed image.

In view of the above-described problem, one example of an object of the present invention is to provide a processing apparatus, a processing method, and a storage medium that solve a problem of preventing inconvenience that a viewer viewing a processed image overlooks a predetermined event captured in the processed image while protecting privacy of a person captured in the processed image.

### Solution to Problem

According to one aspect of the present invention, provided is a processing apparatus including:
a detection unit that detects an object satisfying a predetermined disclosure condition in a processed image;
a mask unit that masks the processed image; and
a display control unit that displays the entirely masked processed image on a display apparatus, and, in a case where the object satisfying the disclosure condition is detected in the processed image, switches an image to be displayed on the display apparatus from the entirely masked processed image to the processed image masked on an area other than an area where the object satisfying the disclosure condition is captured.

According to one aspect of the present invention, provided is a processing method including,
by a computer:
   detecting an object satisfying a predetermined disclosure condition in a processed image;
   masking the processed image; and
   displaying the entirely masked processed image on a display apparatus, and, in a case where the object satisfying the disclosure condition is detected in the processed image, switching an image to be displayed on the display apparatus from the entirely masked processed image to the processed image masked on an area other than an area where the object satisfying the disclosure condition is captured.

According to one aspect of the present invention, provided is a storage medium storing a program causing a computer to function as:
a detection unit that detects an object satisfying a predetermined disclosure condition in a processed image;
a mask unit that masks the processed image; and
a display control unit that displays the entirely masked processed image on a display apparatus, and, in a case where the object satisfying the disclosure condition is detected in the processed image, switches an image to be displayed on the display apparatus from the entirely masked processed image to the processed image masked on an area other than an area where the object satisfying the disclosure condition is captured.

### Advantageous Effects of Invention

According to one aspect of the present invention, a processing apparatus, a processing method, and a storage medium that solve a problem of preventing inconvenience that a viewer viewing a processed image overlooks a predetermined event captured in the processed image while protecting privacy of a person captured in the processed image are achieved.

### BRIEF DESCRIPTION OF THE DRAWINGS

The above-described objective and other objectives, features and advantages are more apparent from the following public example embodiments and the accompanying drawings.

FIG. 1 It is a diagram illustrating one example of a function block diagram of a processing apparatus.

FIG. 2 It is a diagram for describing one example of display of a processed image achieved by the processing apparatus.

FIG. 3 It is a diagram illustrating one example of a hardware configuration of the processing apparatus.

FIG. 4 It is a flowchart illustrating one example of a flow of processing of the processing apparatus.

FIG. 5 It is a diagram for describing another example of display of a processed image achieved by the processing apparatus.

FIG. 6 It is a flowchart illustrating another example of a flow of processing of the processing apparatus.

FIG. 7 It is a diagram for describing another example of display of a processed image achieved by the processing apparatus.

FIG. 8 It is a diagram for describing another example of display of a processed image achieved by the processing apparatus.

FIG. 9 It is a diagram for describing another example of display of a processed image achieved by the processing apparatus.

FIG. 10 It is a diagram for describing one example of a way of setting a trap area.

FIG. 11 It is a diagram for describing another example of display of a processed image achieved by the processing apparatus.

### EXAMPLE EMBODIMENT

Hereinafter, example embodiments of the present invention will be described by using the drawings. Note that, a similar component is assigned with a similar reference sign throughout all the drawings, and description therefor will be omitted as appropriate.

### First Example Embodiment

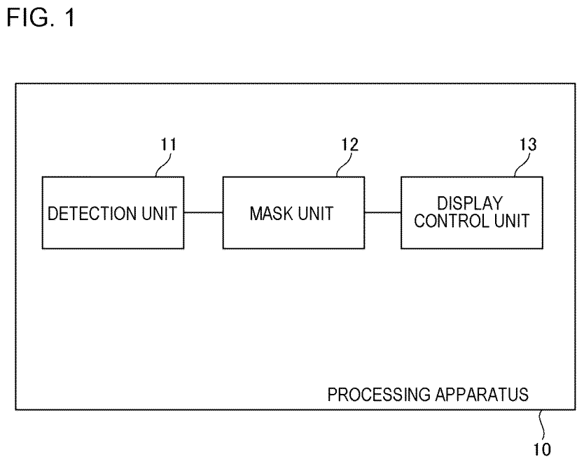

FIG. 1 is a function block diagram illustrating an overview of a processing apparatus 10 according to a first example embodiment. The processing apparatus 10 includes a detection unit 11, a mask unit 12, and a display control unit 13.

The detection unit 11 detects an object satisfying a predetermined disclosure condition in a processed image. The mask unit 12 masks the processed image. The display control unit 13 displays the entirely masked processed image on a display apparatus. Then, the display control unit 13 switches, in a case where the object satisfying the disclosure condition is detected in the processed image, an image to be displayed on the display apparatus from the entirely masked processed image to the processed image masked on an area other than an area where the object satisfying the disclosure condition is captured.

The processing apparatus 10 including such a configuration solves a problem of preventing inconvenience that a viewer viewing a processed image overlooks a predetermined event captured in the processed image while protecting privacy of a person captured in the processed image.

### Second Example Embodiment

### “Overview”

A processing apparatus 10 according to a second example embodiment is a more specific embodiment of the processing apparatus 10 according to the first example embodiment. Herein, an overview of the processing apparatus 10 will be described.

A processed image according to the second example embodiment is a moving image composed of a plurality of frame images. Then, the processing apparatus 10 according to the second example embodiment is used under a condition where there is sufficient time for performing detection processing by a detection unit 11 and mask processing by a mask unit 12, between timing that a frame image is generated and timing that the frame image is displayed. For example, a case in which a captured moving image is reproduction-displayed with a relatively large time lag, a case in which a previously captured moving image is reproduction-displayed at any timing later than capture timing, or the like is assumed.

The processing apparatus 10 performs, on each of a plurality of frame images, processing of detecting an object satisfying a predetermined disclosure condition. Further, the processing apparatus 10 performs, on each of the plurality of frame images, mask processing according to a result of the above detection. Specifically, for a frame image in which an object satisfying a disclosure condition is not detected, the processing apparatus 10 masks the entire frame image. On the other hand, for a frame image in which an object satisfying a disclosure condition is detected, the processing apparatus 10 does not mask an area where the object satisfying the disclosure condition is captured in the frame image, and masks an area other than the area. Then, the processing apparatus 10 reproduction-displays a moving image, based on the plurality of frame images on which such mask processing is performed.

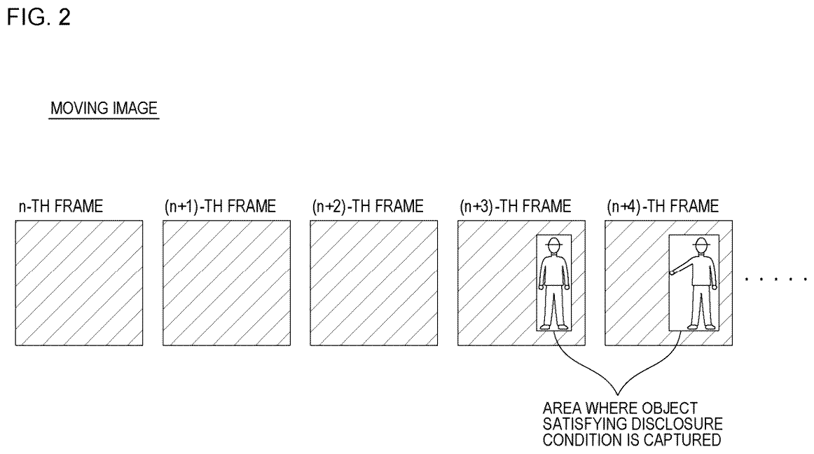

The processing apparatus 10 as described above achieves reproduction display of a moving image as illustrated in FIG. 2. In other words, during a time period that object satisfying a disclosure condition is not detected, an entirely masked image is displayed, as in n-th to (n+2)-th frames. Then, during a time period that an object satisfying a disclosure condition is detected, an image not masked on the object satisfying the disclosure condition and masked on an area other than the object is displayed, as in (n+3)-th and (n+4)-th frames.

### “Hardware Configuration”

Next, one example of a hardware configuration of the processing apparatus 10 will be described. Each function unit of the processing apparatus 10 is achieved by any combination of hardware and software, mainly including a central processing unit (CPU) of any computer, a memory, a program to be loaded in a memory, a storage unit (in which a program downloaded from a storage medium such as a compact disc (CD), a server on the Internet, or the like can be stored as well as a program stored in advance in a stage of shipping an apparatus) such as a hard disk for storing the program, and an interface for network connection. In addition, it might be understood by a person skilled in the art that there are a variety of modified examples of a method or an apparatus for achieving the same.

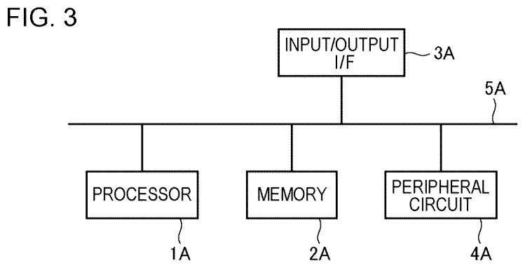

FIG. 3 is a block diagram illustrating a hardware configuration of the processing apparatus 10. As illustrated in FIG. 3, the processing apparatus 10 includes a processor 1A, a memory 2A, an input/output interface 3A, a peripheral circuit 4A, and a bus 5A. The peripheral circuit 4A includes various modules. The processing apparatus 10 may not include the peripheral circuit 4A. Note that, the processing apparatus 10 may be configured by a plurality of physically and/or logically separated apparatuses. In this case, each of the plurality of apparatuses can include the above hardware configuration.

The bus 5A is a data transmission path through which the processor 1A, the memory 2A, the peripheral circuit 4A, and the input/output interface 3A transmit and receive data to and from one another. The processor 1A is an arithmetic processing apparatus such as, for example, a CPU or a graphics processing unit (GPU). The memory 2A is a memory such as, for example, a random access memory (RAM) or a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can give an instruction to each module to perform an operation, based on an operation result thereof.

### “Function Configuration”

Next, a function configuration of the processing apparatus 10 according to the second example embodiment will be described in detail. FIG. 1 illustrates one example of a function block diagram of the processing apparatus 10 according to the second example embodiment. As illustrated, the processing apparatus 10 includes the detection unit 11, the mask unit 12, and a display control unit 13.

The detection unit 11 detects an object satisfying a predetermined disclosure condition in a processed image.

A “processed image” is a moving image composed of a plurality of frame images. The detection unit 11 detects an object satisfying a predetermined disclosure condition in each of a plurality of frame images. Note that, in the following example embodiment, an example in which the processed image is one still image will be described.

An “object” is at least one of a person and an object other than a person.

A “disclosure condition” is a condition under which an object is displayed without mask processing. In other words, an object satisfying a disclosure condition is not masked and is displayed in a determinable state.

A disclosure condition includes, specifically, at least one of:
Being a pre-registered person;
Being not a pre-registered person;
Being a person with a pre-registered feature of appearance;
Being a person who has performed a pre-registered action;
Being a pre-registered object; and
Being an object possessed by a person satisfying a disclosure condition.
   Hereinafter, each of the above will be described.

### —Being a Pre-Registered Person—

In the example, information determining a person (individual) not to be masked, specifically, a feature value of appearance is pre-registered in the processing apparatus 10. The feature value of appearance is, for example, but not limited to, facial information, body shape information, gait information, and the like. Then, the detection unit 11 detects a pre-registered person not to be masked in each of a plurality of frame images, by using a widely known image analysis technique.

Note that, the detection unit 11 may detect, in person detection processing, an area where a person is captured in a frame image, and may thereafter determine, by using the above pre-registered feature value, whether the person present in the detected area where the person is captured is a pre-registered person. Details of the person detection processing and feature value matching processing are not particularly limited, and any technique can be employed.

### —Being not a Pre-Registered Person—

In the example, information determining a person (individual) to be masked, specifically, a feature value of appearance is pre-registered in the processing apparatus 10. Then, the detection unit 11 detects a pre-registered person to be masked in each of a plurality of frame images, by using a widely known image analysis technique.

Note that, the detection unit 11 may detect, in person detection processing, an area where a person is captured in a frame image, and may thereafter determine, by using the above pre-registered feature value, whether the person present in the detected area where the person is captured is a pre-registered person. Details of the person detection processing and feature value matching processing are not particularly limited, and any technique can be employed.

—Being a Person with a Pre-Registered Feature of Appearance—

In the example, a person not to be masked is specified by a feature of appearance such as clothing, belongings, or a pose. For example, a feature of an item worn by a person such as “wearing a mask, sunglasses, and a hat” may be pre-registered. Besides the above, a pose of a person such as “fallen”, “lying down”, or “sitting” may be pre-registered. Besides the above, possession of a predetermined dangerous item such as “possessing a knife” may be pre-registered.

The detection unit 11 is able to detect a person with such a pre-registered feature of appearance in a frame image, by using a widely known person detection technique, an object detection technique, a pose detection technique, or the like.

### —Being a Person Who has Performed a Pre-Registered Action—

In the example, a person not to be masked is specified by an action. For example, an action such as “touched a predetermined object”, “left behind what he/she had”, “prowling”, or “got into a predetermined area” may be pre-registered. The detection unit 11 is able to detect a person who has performed such a pre-registered action in a frame image, by using a widely known action analysis technique.

### —Being a Pre-Registered Object—

For example, a dangerous item such as a “pistol” or a “knife” may be pre-registered. The detection unit 11 is able to detect such a pre-registered object in a frame image, by using a widely known object detection technique.

### —Being an Object Possessed by a Person Satisfying a Disclosure Condition—

The detection unit 11 detects an object possessed by a person satisfying a disclosure condition as described above in a frame image. For example, the detection unit 11 may detect, in a frame image, an object held in a hand of a person satisfying a disclosure condition as described above, an object worn by the person, an object carried on a back of the person, an object carried by the person, an object in contact with the person, or the like, as an object possessed by the person.

Note that, there may be an object that is initially possessed by a person but thereafter is no longer possessed by the person because the person leaves the object behind or the like. The detection unit 11 is also able to detect, in each frame image, an object that is possessed by a person satisfying a disclosure condition but thereafter is no longer possessed by the person, as an “object possessed by a person satisfying a disclosure condition”, by using an object tracking technique, a feature value matching technique, or the like.

The detection unit 11 outputs information indicating whether an object satisfying a predetermined disclosure condition is detected in each frame image and, in a case where it is detected, an area in the frame image where the object satisfying the predetermined disclosure condition is captured.

The mask unit 12 masks a processed image. The mask unit 12 masks each of a plurality of frame images.

The mask unit 12 performs, on each frame image, mask processing according to a result of detection by the detection unit 11. Specifically, for a frame image in which an object satisfying a disclosure condition is not detected, the mask unit 12 masks the entire frame image. On the other hand, for a frame image in which an object satisfying a disclosure condition is detected, the mask unit 12 does not mask an area where the object satisfying the disclosure condition is captured in the frame image, and masks an area other than the area.

“Mask processing” is processing of making an object in an image indeterminable. Mask processing may be processing of pixelating an image with a mosaic technique, may be a technique for blurring an image with a blurring technique, may be a technique for superimposing a predetermined mask image (a monochromatic mask, a pattern mask, or the like) on an image, or may be others.

FIG. 2 illustrates one example of a plurality of frame images after mask processing by the mask unit 12. The n-th to (n+2)-th frames are frame images in which an object satisfying a disclosure condition is not detected. As for the frame images, the entire frame image is masked.

Then, the (n+3)-th and (n+4)-th frames are frame images in which an object satisfying a disclosure condition is detected. As for the frame images, an area where the object satisfying the disclosure condition is captured in the frame image is not masked, and an area other than the area is masked.

Note that, in the example illustrated in FIG. 2, an “area where an object satisfying a disclosure condition is captured” is a rectangular area, but an area where only an object along a contour of the object is captured may be defined as an area where an object satisfying a disclosure condition is captured. A technique for detecting an area where an object is captured as a rectangular area and a technique for detecting an area where only an object along a contour of the object is captured are widely known, and thus, description herein is omitted.

Incidentally, as an approach that generates a frame image not masked on an area where an object satisfying a disclosure condition is captured in the frame image and masked on an area other than the area, (1) an approach that masks an entire frame image and thereafter unmasks an area where an object satisfying a disclosure condition is captured in the frame image and (2) an approach that masks only an area other than an area where an object satisfying a disclosure condition is captured in a frame image can be considered. As in the second example embodiment, in a case where there is sufficient time for performing detection processing by the detection unit 11 and mask processing by the mask unit 12 between timing that a frame image is generated and timing that the frame image is displayed, the mask unit 12 may employ any of the approaches.

The display control unit 13 reproduction-displays a moving image by using frame images on which mask processing is performed by the mask unit 12. Specifically, the display control unit 13 displays, on a display apparatus, a moving image masked on an entire frame image in which an object satisfying a disclosure condition is not detected and masked on an area of a frame image in which an object satisfying a disclosure condition is detected other than an area where the object satisfying the disclosure condition is captured. The display apparatus is a display, a projection apparatus, or the like.

The display control unit 13 as described above achieves display control of displaying an entirely masked frame image (the n-th to (n+2)-th frames) on the display apparatus, and, in a case where an object satisfying a disclosure condition is detected in a frame image, switching an image to be displayed on the display apparatus from the entirely masked frame image to the frame image masked on an area other than an area where the object satisfying the disclosure condition is captured, as illustrated in, for example, FIG. 2.

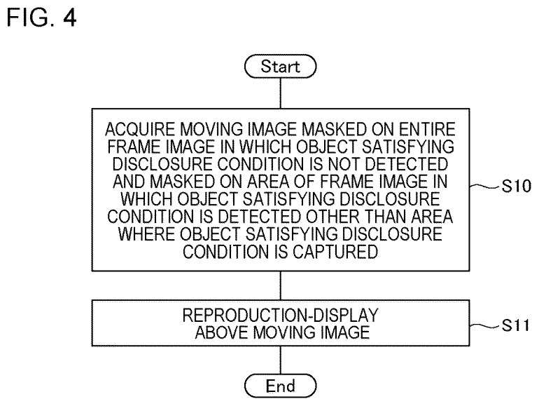

Next, one example of a flow of processing of the processing apparatus 10 according to the second example embodiment will be described by using a flowchart in FIG. 4.

In S10, the processing apparatus 10 acquires a moving image masked on an entire frame image in which an object satisfying a disclosure condition is not detected and masked on an area of a frame image in which an object satisfying a disclosure condition is detected other than an area where the object satisfying the disclosure condition is captured.

For example, a video file in which detection processing by the detection unit 11 and mask processing by the mask unit 12 are performed on all frame images may be generated and stored in advance in a predetermined storage apparatus. Then, the processing apparatus 10 may achieve the above acquisition in S10 by acquiring the video file.

Besides the above, the processing apparatus 10 may sequentially acquire frame images generated while a moving image is captured. Then, the processing apparatus 10 may achieve the above acquisition in S10 by performing detection processing by the detection unit 11 and mask processing by the mask unit 12 sequentially on each of the acquired frame images.

In S11, the processing apparatus 10 reproduction-displays the moving image acquired in S10. Specifically, the processing apparatus 10 displays, on a display apparatus, a moving image masked on an entire frame image in which an object satisfying a disclosure condition is not detected and masked on an area of a frame image in which an object satisfying a disclosure condition is detected other than an area where the object satisfying the disclosure condition is captured.

### Advantageous Effect

The processing apparatus 10 according to the second example embodiment achieves an advantageous effect similar to the processing apparatus 10 according to the first example embodiment.

Further, the processing apparatus 10 according to the second example embodiment displays, during a time period that an object satisfying a disclosure condition is not detected, an entirely masked image as in the n-th to (n+2)-th frames, and displays, during a time period that an object satisfying a disclosure condition is detected, an image not masked on the object satisfying the disclosure condition and masked on an area other than the object as in the (n+3)-th and (n+4)-th frames, as illustrated in FIG. 2.

The processing apparatus 10 according to the second example embodiment as described above displays only an object satisfying a disclosure condition in a determinable state (without mask processing), and displays other objects in an indeterminable state (with mask processing). As a result, inconvenience that a viewer viewing a moving image overlooks a predetermined event, specifically, an event related to an object satisfying a disclosure condition, captured in the moving image can be prevented while protecting privacy of a person captured in the moving image.

Further, the processing apparatus 10 according to the second example embodiment, in a case where an object satisfying a disclosure condition is not detected, masks an entire frame image, and, in a case where an object satisfying a disclosure condition is detected, masks a frame image by an approach that masks an area other than an area of the detected object. In this way, in a case where mask processing is performed by an approach that masks basically and unmasks only an area detected in detection processing, inconvenience of failing to unmask an object to be unmasked may occur due to missed detection in the detection processing, whereas no inconvenience of failing to mask an object not to be unmasked occurs. Thus, more privacy-respecting processing is achieved.

Further, in the processing apparatus 10 according to the second example embodiment, a disclosure condition can include at least one of “being a pre-registered person”, “being not a pre-registered person”, “being a person with a pre-registered feature of appearance”, “being a person who has performed a pre-registered action”, “being a pre-registered object”, and “being an object possessed by a person satisfying a disclosure condition”. The processing apparatus 10 according to the second example embodiment that detects an object to be unmasked by using such a characteristic disclosure condition can define various objects as an object to be unmasked. As a result, it is preferable that the processing apparatus 10 will be used in a wider range of situations.

### Third Example Embodiment

A processed image according to a third example embodiment is a moving image composed of a plurality of frame images. Then, a processing apparatus 10 according to the third example embodiment is used under a condition where there is no time for performing detection processing by a detection unit 11 and mask processing by a mask unit 12 described in the second example embodiment, between timing that a frame image is generated and timing that the frame image is displayed. For example, a case in which a captured moving image is reproduction-displayed in real time with a relatively small time lag or the like is assumed.

In a case of the third example embodiment as well, the detection unit 11 detects an object satisfying a predetermined disclosure condition in each of a plurality of frame images, similarly to the second example embodiment. Then, in a case where an object satisfying a predetermined disclosure condition is detected in a certain frame image, the detection unit 11 tracks the object in subsequent frame images as an object to be tracked. Tracking of an object in a moving image is achieved by using a widely known tracking technique. Then, the detection unit 11 outputs information indicating an area where the object to be tracked detected in a frame image is captured.

The mask unit 12 performs, on each frame image, mask processing according to a result of detection by the detection unit 11. Specifically, for a frame image in which an object to be tracked (an object satisfying a disclosure condition) is not detected, the mask unit 12 masks the entire frame image. On the other hand, for a frame image in which an object to be tracked (an object satisfying a disclosure condition) is detected, the mask unit 12 does not mask an area where the object to be tracked is captured in the frame image, and masks an area other than the area.

Note that, processing of detecting an object to be tracked in a frame image imposes less processing load on a computer than processing of detecting an object satisfying a disclosure condition in a frame image, and the processing can be completed in a short period of time. Thus, it becomes possible to perform processing of detecting an object to be tracked by the detection unit 11 and mask processing by the mask unit 12, between timing that a frame image is generated and timing that the frame image is displayed.

Other configurations of the processing apparatus 10 according to the third example embodiment are similar to the processing apparatus 10 according to the first and second example embodiments.

The processing apparatus 10 according to the third example embodiment achieves an advantageous effect similar to the processing apparatus 10 according to the first and second example embodiments. In other words, the processing apparatus 10 according to the third example embodiment is able to reproduction-display a moving image masked on a person not satisfying a predetermined disclosure condition among persons captured in the moving image and not masked on a person satisfying the predetermined disclosure condition.

Note that, in the third example embodiment, a case in which a captured moving image is reproduction-displayed in real time with a relatively small time lag or the like is assumed. Thus, a period of time between generation and display of a certain frame image is relatively small. Then, processing by the detection unit 11 and the mask unit 12 needs to be executed in such a relatively small period of time.

Due to time limitation as described above, even though an object satisfying a disclosure condition is detected in a certain frame image, the object cannot be unmasked from the frame image and displayed. This is because by the time processing of detecting an object satisfying a disclosure condition in the frame image and mask processing according to a result of the detection are completed, display timing of the frame image will have passed. Thus, the detected object satisfying the disclosure condition is displayed in a masked state in the frame image. However, the object can be tracked in subsequent frame images with a tracking technique, and the object can be displayed in an unmasked state in the subsequent frame images. In this way, in a case of the third example embodiment, although an object satisfying a disclosure condition cannot be unmasked from a frame image in which the object is detected, the object can be unmasked from any subsequent frame images and displayed.

### Fourth Example Embodiment

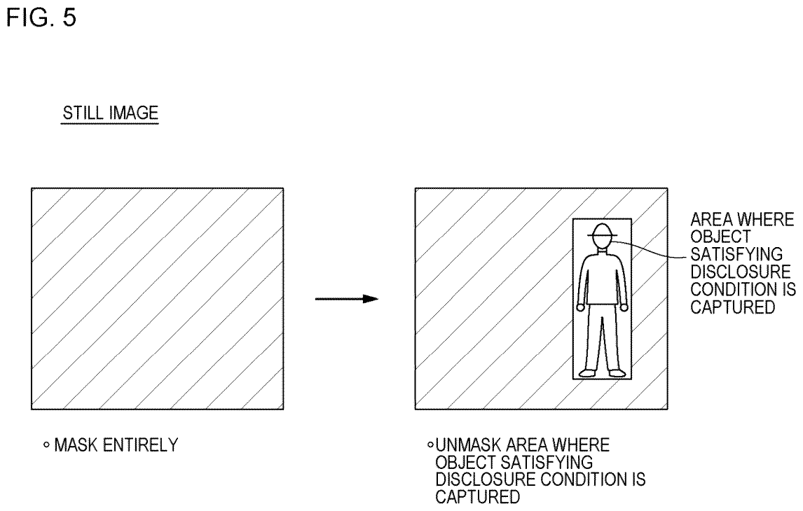

First, an overview of a processing apparatus 10 according to a fourth example embodiment will be described. A processed image according to the fourth example embodiment is a “still image”. After accepting a display instruction input to display a certain still image, the processing apparatus 10 masks the entire still image in response thereto, and displays the masked still image. Further, the processing apparatus 10 performs processing of detecting, in response to the above display instruction input, an object satisfying a predetermined disclosure condition in the still image. Next, in a case where an object satisfying a predetermined disclosure condition is detected in the still image, the processing apparatus 10 generates a still image not masked on an area where the object satisfying the disclosure condition is captured and masked on an area other than the area. Then, the processing apparatus 10 switches an image to be displayed from the entirely masked still image to the still image not masked on an area where the object satisfying the disclosure condition is captured and masked on an area other than the area. As a result, display in which the entirely masked still image is initially displayed and thereafter an area where the object satisfying the disclosure condition is captured is unmasked is achieved, as illustrated in FIG. 5.

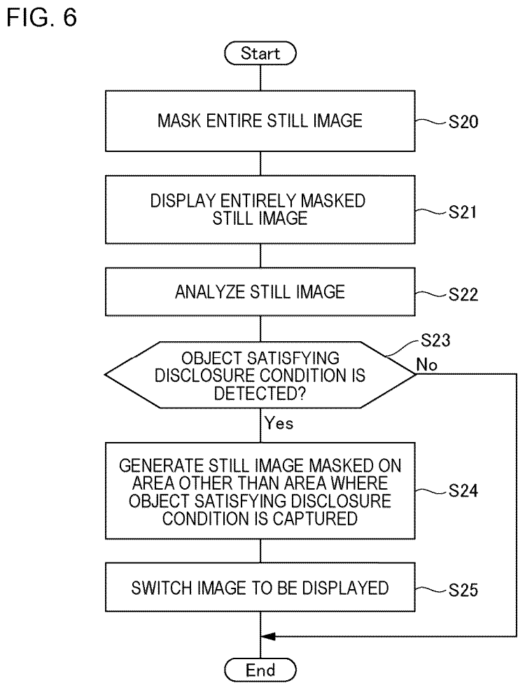

A flow of processing of the processing apparatus 10 will be described in detail by using a flowchart in FIG. 6.

In a case where the processing apparatus 10 accepts an instruction input to specify a file of a certain still image and display the still image, processing of S20 to S25 in FIG. 6 is performed.

First, the mask unit 12 masks an entire specified still image (S20). Then, the display control unit 13 displays the entirely masked still image on a display apparatus (S21).

Further, the detection unit 11 analyzes the specified still image, and detects an object satisfying a predetermined disclosure condition in the still image (S22). Note that, the processing of S22 may be performed after the processing of S20 and S21, or may be performed in parallel with the processing of S20 and S21.

In a case where an object satisfying a disclosure condition is detected in the still image (Yes in S23), the mask unit 12 generates a still image not masked on an area where the object satisfying the disclosure condition is captured and masked on an area other than the area (S24). For example, the mask unit 12 may achieve the generation processing in S24, by processing of unmasking, from the entirely masked still image generated in S20, an area where the object satisfying the disclosure condition is captured. Besides the above, the mask unit 12 may achieve the generation processing in S24, by processing of masking, on the not-masked still image, an area other than an area where the object satisfying the disclosure condition is captured.

Next, the display control unit 13 switches an image to be displayed on the display apparatus from the entirely masked still image to the still image not masked on an area where the object satisfying the disclosure condition is captured and masked on an area other than the area. As a result, display in which the entirely masked still image is initially displayed and thereafter an area where the object satisfying the disclosure condition is captured is unmasked is achieved, as illustrated in FIG. 5.

Note that, in a case where an object satisfying a disclosure condition is not detected in the still image (No in S23), the processing of S24 and S25 is not executed. In this case, display of the entirely masked still image is continued.

Other configurations of the processing apparatus 10 according to the fourth example embodiment are similar to the configurations of the processing apparatus 10 according to the first to third example embodiments.

The processing apparatus 10 according to the fourth example embodiment achieves an advantageous effect similar to the processing apparatus 10 according to the first to third example embodiments, even though displaying a still image.

Further, the processing apparatus 10 according to the fourth example embodiment is able to display an entirely masked still image on a display apparatus, and, in a case where an object satisfying a disclosure condition is detected in the still image, is able to switch an image to be displayed on the display apparatus from the entirely masked still image to the still image masked on an area other than an area where the object satisfying the disclosure condition is captured.

It is also possible to display, immediately in response to an instruction input to display a still image, a still image (a right-side still image in FIG. 5) on which mask processing reflecting a result of detection by the detection unit 11 is performed. However, in this case, due to time required for detection processing by the detection unit 11, time between a display instruction input and display of a still image is increased. In a case where time between an instruction input to display a still image and display of the still image is increased, some users may feel stressed. The problem of the above users' stress can be reduced by first generating and promptly displaying an entirely masked generated image according to the instruction input to display the still image, and thereafter displaying the still image on which mask processing reflecting a result of detection by the detection unit 11 is performed, as in the processing apparatus 10 according to the fourth example embodiment.

### Fifth Example Embodiment

A detection unit 11 of a processing apparatus 10 according to a fifth example embodiment detects, in person detection processing, an area where a person is captured in a frame image, and thereafter determines whether the person present in the detected area where the person is captured satisfies a disclosure condition. In other words, the detection unit 11 executes at least two steps of “detecting an area where a person is captured” and “determining whether the person present in the detected area where the person is captured satisfies a disclosure condition”.

Then, a mask unit 12 performs stepwise mask processing on a processed image according to a result of processing in each of the above two steps by the detection unit 11.

First, the mask unit 12 generates, according to detection of an area where a person is captured, a processed image masked on an area other than the detected area where the person is captured, masked on a part of a body of the person present in the detected area where the person is captured, and not masked on another part. A part of a body to be masked is, for example, a part capable of determining the person such as a “face”. Note that, a processed image in which an area where a person is captured is not detected is entirely masked.

Next, the mask unit 12 performs mask processing according to a result of determination as to whether the person present in the detected area where the person is captured satisfies a disclosure condition. Specifically, in a case where the person present in the detected area where the person is captured satisfies a disclosure condition, the mask unit 12 generates a processed image masked on an area other than the detected area where the person is captured and not masked on the detected area where the person is captured. In other words, the part (example: face) of the body is unmasked. Note that, in a case where the person present in the detected area where the person is captured does not satisfy a disclosure condition, the mask unit 12 generates a processed image masked on an area other than the detected area where the person is captured, masked on a part of a body of the person present in the detected area where the person is captured, and not masked on another part.

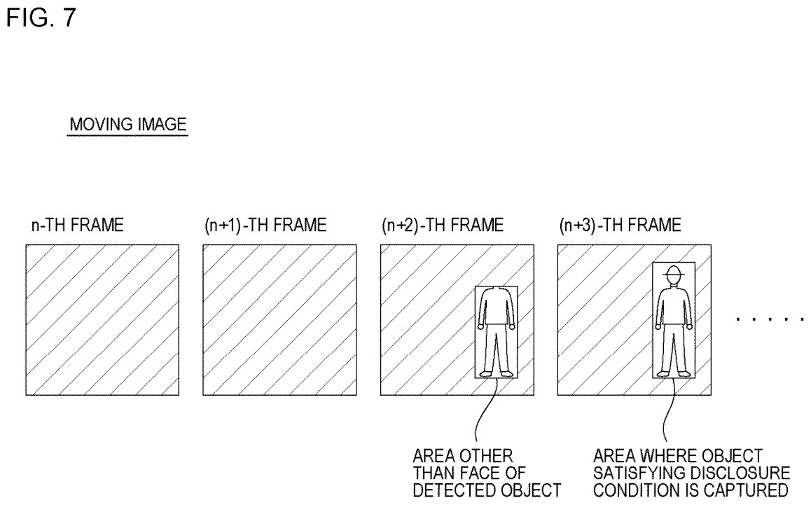

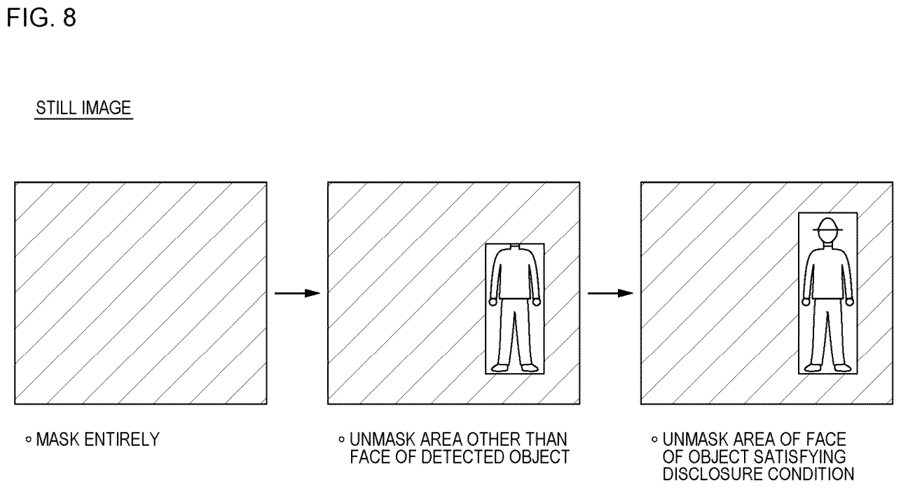

A specific example of display achieved by the processing apparatus 10 will be illustrated by using FIGS. 7 and 8. FIG. 7 is processing on the premise of the configuration of the processing apparatus 10 according to the third example embodiment. As illustrated, during a time period that an area where a person is captured is not detected, an entirely masked image is displayed, as in n-th and (n+1)-th frames. Then, during a time period that an area where a person is captured is detected but whether the person satisfies a disclosure condition is not determined, an image masked on an area other than the detected area where the person is captured, masked on a part (example: face) of a body of the person present in the detected area where the person is captured, and not masked on another part is displayed, as in an (n+2)-th frame.

Thereafter, in a case where it is determined that the person satisfies a disclosure condition, an image masked on an area other than the detected area where the person is captured and not masked on the detected area where the person is captured is displayed, as in an (n+3)-th frame. In other words, the part (example: face) of the body of the person present in the detected area where the person is captured is unmasked. Note that, in FIG. 7, only one frame ((n+2)-th frame) of the image masked on an area other than the detected area where the person is captured and masked on the part (example: face) of the body of the person present in the detected area where the person is captured is displayed, but several frames may be displayed.

FIG. 8 is processing on the premise of the configuration of the processing apparatus 10 according to the fourth example embodiment. According to a display instruction input to display a still image, an entirely masked still image is displayed. Next, according to detection of an area where a person is captured, a still image masked on an area other than the detected area where the person is captured, masked on a part (example: face) of a body of the person present in the detected area where the person is captured, and not masked on another part is displayed. Thereafter, in a case where it is determined that the person satisfies a disclosure condition, an image masked on an area other than the detected area where the person is captured and not masked on the detected area where the person is captured is displayed. In other words, the part (example: face) of the body of the person present in the detected area where the person is captured is unmasked.

Other configurations of the processing apparatus 10 according to the fifth example embodiment are similar to the configurations of the processing apparatus 10 according to the first to fourth example embodiments.

The processing apparatus 10 according to the fifth example embodiment achieves an advantageous effect similar to the processing apparatus 10 according to the first to fourth example embodiments. Further, the processing apparatus 10 according to the fifth example embodiment is able to execute at least two steps of “detecting an area where a person is captured” and “determining whether the person present in the detected area where the person is captured satisfies a disclosure condition”, and is able to perform stepwise mask processing on a processed image according to a result of processing in each of the above two steps. The processing apparatus 10 as described above is able to reduce time for displaying the entirely masked processed image. As a result, viewer's stress caused by display of the entirely masked processed image can be reduced.

Further, the display can notify a viewer that a person is captured in a processed image while protecting privacy of the person captured in the processed image.

### Sixth Example Embodiment

A mask unit 12 of a processing apparatus 10 according to a sixth example embodiment performs mask processing by an approach that does not unmask an entire object satisfying a disclosure condition, but rather masks a part of the object and does not mask another part.

Then, a display control unit 13 displays, on a display apparatus, a processed image masked on an area where an object satisfying a disclosure condition is not captured, further masked on a part of an area where the object satisfying the disclosure condition is captured, and not masked on another part, as the processed image masked on an area other than an area where the object satisfying the disclosure condition is captured.

The mask unit 12 masks, on a processed image in which a person satisfying a disclosure condition is detected, an area where an object satisfying a disclosure condition is not captured, further masks a part of an area where the object satisfying the disclosure condition is captured, and does not mask another part. A part (example: body part) to be masked in an area where the object satisfying the disclosure condition is captured and a part not to be masked may be determined in advance.

Further, the mask unit 12 may change a part to be masked in an area where the object satisfying the disclosure condition is captured and a part not to be masked, according to a content of the disclosure condition satisfied by the object.

For example, in a case where the satisfied disclosure condition is any of “being a pre-registered person”, “being not a pre-registered person”, “being a pre-registered object”, and “being an object possessed by a person satisfying a disclosure condition”, all of areas where the object is captured may not be masked.

Then, in a case where the satisfied disclosure condition is any of “being a person with a pre-registered feature of appearance” and “being a person who has performed a pre-registered action”, mask processing may be performed by an approach that masks a face of a person satisfying the disclosure condition and does not mask another part of a body or belongings of the person.

Further, in a case where the satisfied disclosure condition is “being a person who has performed a pre-registered action”, a part to be masked in an area where the object satisfying the disclosure condition is captured and a part not to be masked may be changed according to a content of the action.

For example, in a case where the pre-registered action performed by a person satisfying the disclosure condition is that “a predetermined part of a body is included in a trap area set in a processed image”, the mask unit 12 may perform mask processing by an approach that does not mask the predetermined part of a person whose predetermined part of a body is included in the trap area and masks a part other than the predetermined part. The example will be described below in detail.

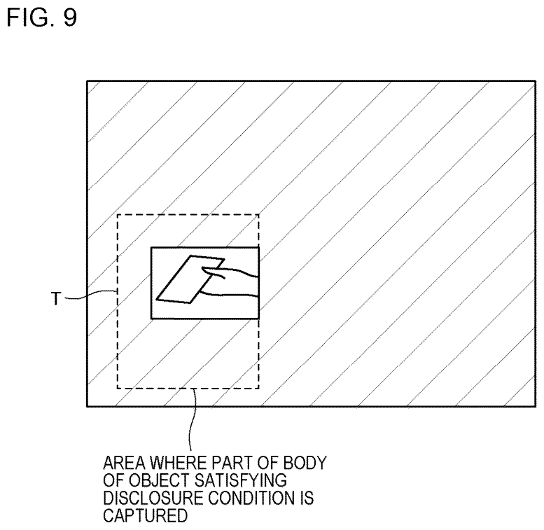

As illustrated in FIG. 9, a partial area in a processed image is set as a trap area T in advance. For example, an entry prohibited area in a space captured in a processed image or a partial area in the processed image in which a not-to-be-touched object or the like present in the space is captured is set as the trap area T. In a case where the processed image is generated by a camera with fixed installation position and orientation, the entry prohibited area or the not-to-be-touched object in the processed image is in a fixed position in the processed image.

A predetermined part of a body detected as being included a trap area is, for example, an “arm”, a “leg”, or the like. A predetermined part of a body detected as being included may be different for each trap area. For example, an arm may be detected as being included in a first trap area, and a leg may be detected as being included in a second trap area.

In the example in FIG. 9, an arm is detected as being included in the trap area T. Then, as illustrated in FIG. 9, only the arm of a person is displayed without mask processing according to detection of the arm being included in the trap area T.

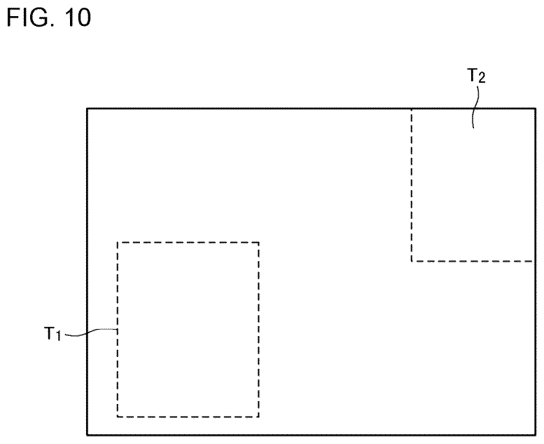

Further, as illustrated in FIG. 10, a plurality of trap areas may be set in a processed image. In FIG. 10, two trap areas T₁ and T₂ are set. A predetermined part of a body detected as being included in each of the plurality of trap areas set in the processed image may be common or different from each other.

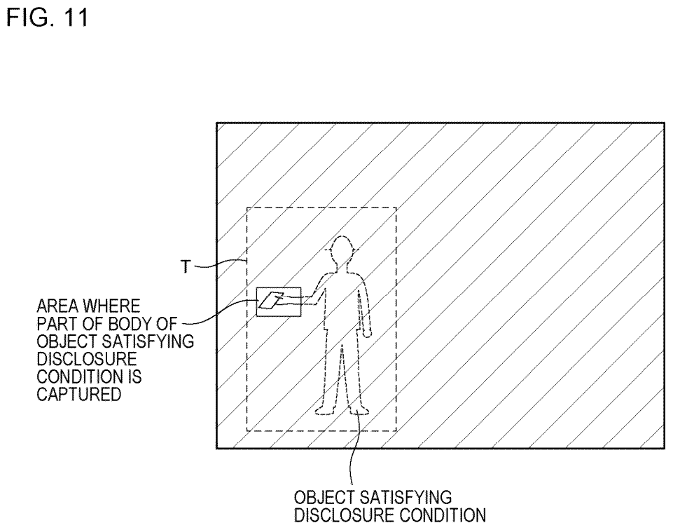

Further, as illustrated in FIG. 11, even though a part other than a predetermined part (an arm in a case in FIG. 11) of a body detected as being included in a trap area T is included in the trap area T, the mask unit 12 is able to perform mask processing by an approach that does not mask the predetermined part of a person whose predetermined part of a body is included in the trap area and masks a part other than the predetermined part. In FIG. 11, although a part other than the arm is also included in the trap area T, only the arm is not masked and the other part is masked.

Other configurations of the processing apparatus 10 according to the sixth example embodiment are similar to the configurations of the processing apparatus 10 according to the first to fifth example embodiments.

The processing apparatus 10 according to the sixth example embodiment achieves an advantageous effect similar to the processing apparatus 10 according to the first to fifth example embodiments. Further, the processing apparatus 10 according to the sixth example embodiment is able to perform mask processing by an approach that does not unmask an entire object satisfying a disclosure condition, but rather masks a part of the object and does not mask another part. Use of the approach allows a viewer to be able to recognize a predetermined event while protecting privacy of an object satisfying a disclosure condition. Further, it is preferable that a usage range becomes wider, since the approach of masking can be partially changed according to a content of a disclosure condition.

While the example embodiments of the present invention have been described above with reference to the drawings, the example embodiments are exemplifications of the present invention, and various configurations other than the above can be employed. The configurations of the above-described example embodiments may be combined with each another, or a part of the configurations may be replaced with another configuration. Further, various modifications may be applied to the configurations of the above-described example embodiments, as long as such modifications do not depart from the gist. Further, the configurations and processing disclosed in the above-described example embodiments and the modified examples may be combined with each other.

Further, while a plurality of processes (pieces of processing) are described in order in a plurality of flowcharts used in the above description, execution order of processes executed in each example embodiment is not limited to the described order. The order of the illustrated processes can be changed in each example embodiment, as long as the change does not detract from contents. Further, the above example embodiments can be combined, as long as contents do not contradict each other.

The whole or part of the above-described example embodiments can be described as, but not limited to, the following supplementary notes.

1. A processing apparatus including:
a detection unit that detects an object satisfying a predetermined disclosure condition in a processed image;
a mask unit that masks the processed image; and
a display control unit that displays the entirely masked processed image on a display apparatus, and, in a case where the object satisfying the disclosure condition is detected in the processed image, switches an image to be displayed on the display apparatus from the entirely masked processed image to the processed image masked on an area other than an area where the object satisfying the disclosure condition is captured.
   2. The processing apparatus according to supplementary note 1, wherein
the processed image is a moving image composed of a plurality of frame images, and
the display control unit displays, on the display apparatus, the moving image masked on an entire frame image in which the object satisfying the disclosure condition is not detected and masked on an area of a frame image in which the object satisfying the disclosure condition is detected other than an area where the object satisfying the disclosure condition is captured.
   3. The processing apparatus according to supplementary note 1, wherein
the processed image is a still image, and
the display control unit displays the entirely masked still image on the display apparatus according to a display instruction input, and, in a case where the object satisfying the disclosure condition is detected in the still image, switches an image to be displayed on the display apparatus from the entirely masked still image to the still image masked on an area other than an area where the object satisfying the disclosure condition is captured.
   4. The processing apparatus according to any one of supplementary notes 1 to 3, wherein
the disclosure condition includes at least one of
   being a pre-registered person,
   being not a pre-registered person,
   being a person with a pre-registered feature of appearance,
   being a person who has performed a pre-registered action,
   being a pre-registered object, and
   being an object possessed by a person satisfying the disclosure condition.
      5. The processing apparatus according to any one of supplementary notes 1 to 4, wherein
the display control unit displays, on the display apparatus, the processed image further masked on a part of an area where the object satisfying the disclosure condition is captured and not masked on another part, as the processed image masked on an area other than an area where the object satisfying the disclosure condition is captured.
   6. The processing apparatus according to supplementary note 5, wherein
the mask unit changes a part to be masked in an area where the object satisfying the disclosure condition is captured and a part not to be masked, according to a content of the disclosure condition satisfied by the object.
   7. The processing apparatus according to supplementary note 6, wherein
the disclosure condition is that a predetermined part of a body is included in a trap area set in the processed image, and
the mask unit does not mask the predetermined part of a person whose predetermined part of a body is included in the trap area, and masks a part other than the predetermined part.
   8. The processing apparatus according to supplementary note 7, wherein
a plurality of the trap areas are set in the processed image, and
the predetermined part of a body is different for each of the trap areas.
   9. A processing method including,
by a computer:
   detecting an object satisfying a predetermined disclosure condition in a processed image;
   masking the processed image; and
   displaying the entirely masked processed image on a display apparatus, and, in a case where the object satisfying the disclosure condition is detected in the processed image, switching an image to be displayed on the display apparatus from the entirely masked processed image to the processed image masked on an area other than an area where the object satisfying the disclosure condition is captured.
      10. A storage medium storing a program causing a computer to function as:
a detection unit that detects an object satisfying a predetermined disclosure condition in a processed image;
a mask unit that masks the processed image; and
a display control unit that displays the entirely masked processed image on a display apparatus, and, in a case where the object satisfying the disclosure condition is detected in the processed image, switches an image to be displayed on the display apparatus from the entirely masked processed image to the processed image masked on an area other than an area where the object satisfying the disclosure condition is captured.

### REFERENCE SIGNS LIST

10 Processing apparatus
11 Detection unit
12 Mask unit
13 Display control unit
1A Processor
2A Memory
3A Input/output I/F
4A Peripheral circuit
5A Bus

What is claimed is:

1. A processing apparatus comprising:
at least one memory configured to store one or more instructions; and
at least one processor configured to execute the one or more instructions to:
detect an object satisfying a predetermined disclosure condition in a processed image;
mask the processed image; and
display the entirely masked processed image on a display apparatus, and, in a case where the object satisfying the disclosure condition is detected in the processed image, switch an image to be displayed on the display apparatus from the entirely masked processed image to the processed image masked on an area other than an area where the object satisfying the disclosure condition is captured.

2. The processing apparatus according to claim 1, wherein
the processed image is a moving image composed of a plurality of frame images, and
the at least one processor is further configured to execute the one or more instructions to display, on the display apparatus, the moving image masked on an entire frame image in which the object satisfying the disclosure condition is not detected and masked on an area of a frame image in which the object satisfying the disclosure condition is detected other than an area where the object satisfying the disclosure condition is captured.

3. The processing apparatus according to claim 1, wherein
the processed image is a still image, and
the at least one processor is further configured to execute the one or more instructions to display the entirely masked still image on the display apparatus according to a display instruction input, and, in a case where the object satisfying the disclosure condition is detected in the still image, switch an image to be displayed on the display apparatus from the entirely masked still image to the still image masked on an area other than an area where the object satisfying the disclosure condition is captured.

4. The processing apparatus according to claim 1, wherein the disclosure condition includes at least one of
being a pre-registered person,
being not a pre-registered person,
being a person with a pre-registered feature of appearance,
being a person who has performed a pre-registered action,
being a pre-registered object, and
being an object possessed by a person satisfying the disclosure condition.

5. The processing apparatus according to claim 1, wherein
the at least one processor is further configured to execute the one or more instructions to display, on the display apparatus, the processed image further masked on a part of an area where the object satisfying the disclosure condition is captured and not masked on another part, as the processed image masked on an area other than an area where the object satisfying the disclosure condition is captured.

6. The processing apparatus according to claim 5, wherein
the at least one processor is further configured to execute the one or more instructions to change a part to be masked in an area where the object satisfying the disclosure condition is captured and a part not to be masked, according to a content of the disclosure condition satisfied by the object.

7. The processing apparatus according to claim 6, wherein
the disclosure condition is that a predetermined part of a body is included in a trap area set in the processed image, and
the at least one processor is further configured to execute the one or more instructions not to mask the predetermined part of a person whose predetermined part of a body is included in the trap area, and mask a part other than the predetermined part.

8. The processing apparatus according to claim 7, wherein
a plurality of the trap areas are set in the processed image, and
the predetermined part of a body is different for each of the trap areas.

9. A processing method comprising,
by a computer:
detecting an object satisfying a predetermined disclosure condition in a processed image;
masking the processed image; and
displaying the entirely masked processed image on a display apparatus, and, in a case where the object satisfying the disclosure condition is detected in the processed image, switching an image to be displayed on the display apparatus from the entirely masked processed image to the processed image masked on an area other than an area where the object satisfying the disclosure condition is captured.

10. A non-transitory storage medium storing a program causing a computer to:
detect an object satisfying a predetermined disclosure condition in a processed image;
mask the processed image; and
display the entirely masked processed image on a display apparatus, and, in a case where the object satisfying the disclosure condition is detected in the processed image, switch an image to be displayed on the display apparatus from the entirely masked processed image to the processed image masked on an area other than an area where the object satisfying the disclosure condition is captured.

11. The processing method according to claim 9, wherein
the processed image is a moving image composed of a plurality of frame images, and
the computer displays, on the display apparatus, the moving image masked on an entire frame image in which the object satisfying the disclosure condition is not detected and masked on an area of a frame image in which the object satisfying the disclosure condition is detected other than an area where the object satisfying the disclosure condition is captured.

12. The processing method according to claim 9, wherein
the processed image is a still image, and
the computer displays the entirely masked still image on the display apparatus according to a display instruction input, and, in a case where the object satisfying the disclosure condition is detected in the still image, switches an image to be displayed on the display apparatus from the entirely masked still image to the still image masked on an area other than an area where the object satisfying the disclosure condition is captured.

13. The processing method according to claim 9, wherein
the disclosure condition includes at least one of
being a pre-registered person,
being not a pre-registered person,
being a person with a pre-registered feature of appearance,
being a person who has performed a pre-registered action,
being a pre-registered object, and
being an object possessed by a person satisfying the disclosure condition.

14. The processing method according to claim 9, wherein
the computer displays, on the display apparatus, the processed image further masked on a part of an area where the object satisfying the disclosure condition is captured and not masked on another part, as the processed image masked on an area other than an area where the object satisfying the disclosure condition is captured.

15. The processing method according to claim 14, wherein
the computer changes a part to be masked in an area where the object satisfying the disclosure condition is captured and a part not to be masked, according to a content of the disclosure condition satisfied by the object.

16. The non-transitory storage medium according to claim 10, wherein
the processed image is a moving image composed of a plurality of frame images, and
the program causing the computer to display, on the display apparatus, the moving image masked on an entire frame image in which the object satisfying the disclosure condition is not detected and masked on an area of a frame image in which the object satisfying the disclosure condition is detected other than an area where the object satisfying the disclosure condition is captured.

17. The non-transitory storage medium according to claim 10, wherein
the processed image is a still image, and
the program causing the computer to display the entirely masked still image on the display apparatus according to a display instruction input, and, in a case where the object satisfying the disclosure condition is detected in the still image, switch an image to be displayed on the display apparatus from the entirely masked still image to the still image masked on an area other than an area where the object satisfying the disclosure condition is captured.

18. The non-transitory storage medium according to claim 10, wherein
the disclosure condition includes at least one of
being a pre-registered person,
being not a pre-registered person,
being a person with a pre-registered feature of appearance,
being a person who has performed a pre-registered action,
being a pre-registered object, and
being an object possessed by a person satisfying the disclosure condition.

19. The non-transitory storage medium according to claim 10, wherein
the program causing the computer to display, on the display apparatus, the processed image further masked on a part of an area where the object satisfying the disclosure condition is captured and not masked on another part, as the processed image masked on an area other than an area where the object satisfying the disclosure condition is captured.

20. The non-transitory storage medium according to claim 19, wherein
the program causing the computer to change a part to be masked in an area where the object satisfying the disclosure condition is captured and a part not to be masked, according to a content of the disclosure condition satisfied by the object.
